(19) United States
(12) Patent Application Publication
(10) Pub. No.: US 2009/0001683 A1
(43) Pub. Date: Jan. 1, 2009

(54) Steering Damping Apparatus of Two-Wheeled Vehicle

(75) Inventor: Kojiro Yoshida, Fukuoi-shi (JP)

Correspondence Address: BABCOCK IP, PLLC, P.O.BOX 488, BRIDGMAN, MI, 49106, US

(73) Assignee: SHOWA CORPORATION, Gyoda-shi (JP)

(21) Appl. No.: 11/953,213

(22) Filed: Dec. 10, 2007

(30) Foreign Application Priority Data
Jun. 27, 2007 (JP) 2007-169478

(51) Int. Cl. B62K 21/08

(52) U.S. Cl. 280/270

(57) ABSTRACT

In a steering damping apparatus of a motorcycle in which a steering shaft is pivoted to a head pipe in a front end of a vehicle body frame, and a handlebar is attached to a steering bracket attached to the steering shaft, a casing of a rotary damper is fixed to a front surface lacing to a front side in a vehicle forward moving direction of the head pipe, and the steering damping apparatus has a rotation transmitting means for rotating a rotor shaft of the rotary damper from a neutral position on the basis of a rotation of the steering bracket from a neutral steering position.

### BACKGROUND OF THE INVENTION

1. Field of the Invention

The present invention relates to a steering damping apparatus for a two-wheeled vehicle.

2. Description of the Related Art

In a motorcycle, a steering shaft is pivoted to a head pipe in a front end of a vehicle body frame, centers of upper and lower steering brackets are attached to the steering shaft, upper tubes of right and left front forks are attached to both sides of the upper and lower steering brackets, and an axle of a front wheel is attached to lower tubes of the right and left front forks.

In the motorcycle mentioned above, as a steering damping apparatus, there is a structure in which a handlebar is attached to an upper surface of an upper steering bracket, a casing of a rotary damper is fixed thereto, and a free end of an arm firmly attached to a rotary shaft of the rotary damper is fixed to a vehicle body frame side, as described in Japanese Patent No. 2593461 (patent document 1). Since the casing follows a rotating motion in a steering direction of the upper steering bracket, and a rotor shaft is firmly attached to a vehicle body frame side via an arm, the rotary damper can apply a damping force with respect to a rapid oscillation of a front wheel, and can reduce an oscillating vibration (an erratic oscillation) of the front wheel.

In the steering damping apparatus described in Japanese Patent No. 2593461 (patent document 1), the casing of the rotary damper is fixed to an upper surface of an upper steering bracket to which the handlebar is attached, and the rotary damper consumes a large front surface space between a rider and the handlebar. Accordingly, a steering motion of the rider is prevented by the rotary damper, and it is hard to put the rotary damper into actual use particularly in a competitive motocross.

### SUMMARY OF THE INVENTION

An object of the present invention is to provide a steering damping apparatus which does not prevent a steering motion of a rider in a motorcycle.

The present invention relate to a steering damping apparatus of a motorcycle in which a steering shaft is pivoted to a head pipe in a front end of a vehicle body frame, and a handlebar is attached to a steering bracket attached to the steering shaft. A casing of a rotary damper is fixed to a front surface facing a front side in a vehicle forward moving direction of the head pipe. The steering damping apparatus has a rotation transmitting means for rotating a rotor shaft of the rotary damper from a neutral position on the basis of a rotation of the steering bracket from a neutral steering position.

### BRIEF DESCRIPTION OF THE DRAWINGS

The present invention will be more fully understood from the detailed description given below and from the accompanying drawings which should not be taken to be a limitation on the invention, but are for explanation and understanding only.

The drawings:

FIG. 1 is a front elevational view showing a steering damping apparatus of a motorcycle;

FIG. 2 is a front elevational partial split view showing a rotating state from a neutral steering position of a steering bracket;

FIGS. 3A and 3B show the steering damping apparatus, in which FIG. 3A is a plan view showing a neutral steering state, and FIG. 3B is a plan view showing a rotating state from the neutral steering position;

FIGS. 4A and 4B show the steering damping apparatus, in which FIG. 4A is a side elevational view showing the neutral steering state, and FIG. 4B is a side elevational view showing the rotating state from the neutral steering position;

FIGS. 5A and 5B show a cross section of a rotary damper, in which FIG. 5A is a cross sectional view along a line A-A in FIG. 4A, and FIG. 5B is a cross sectional view along a line BB in FIG. 4A;

FIGS. 6A and 6B show a second shaft, in which FIG. 6A is a front elevational view, and FIG. 6B is a side elevational view;

FIGS. 7A and 7B show an oscillating joint, in which FIG. 7A is a front elevational view, and FIG. 7B is a side elevational view; and

FIGS. 8A and 8B show a rotor shaft of a rotary damper, in which FIG. 8A is a front elevational view, and FIG. 8B is a side elevational view.

### DESCRIPTION OF THE PREFERRED EMBODIMENTS

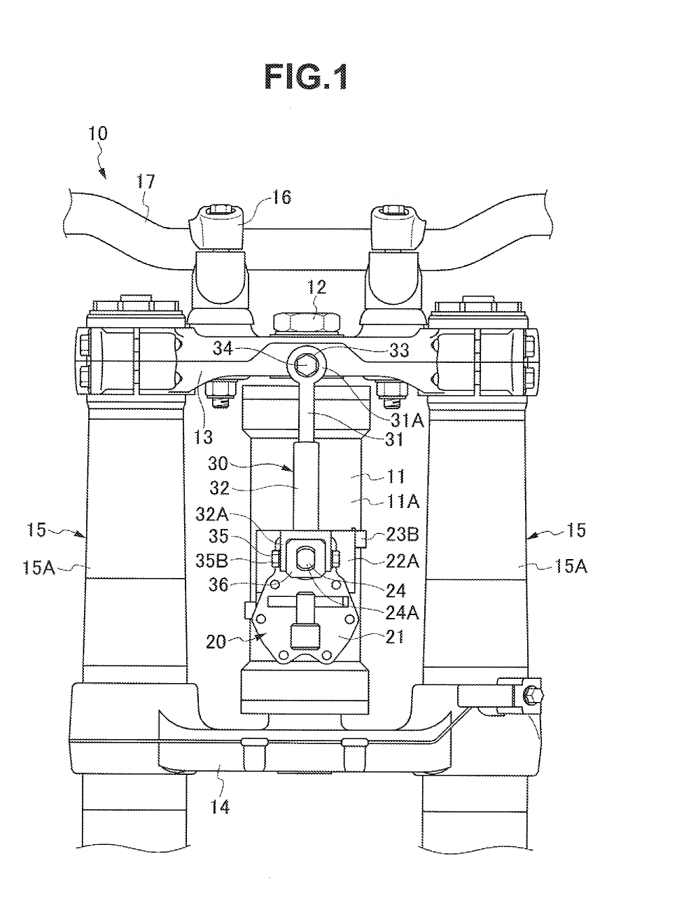

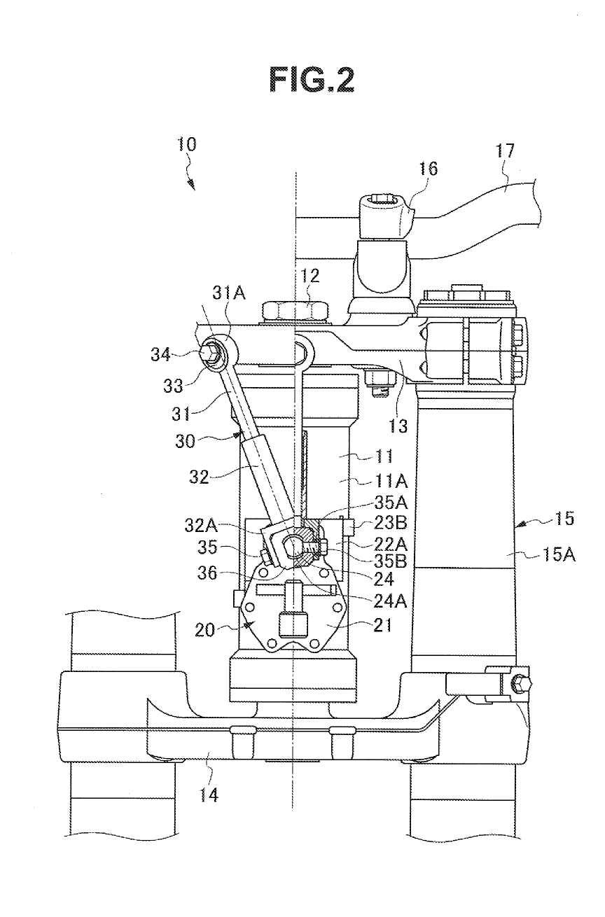

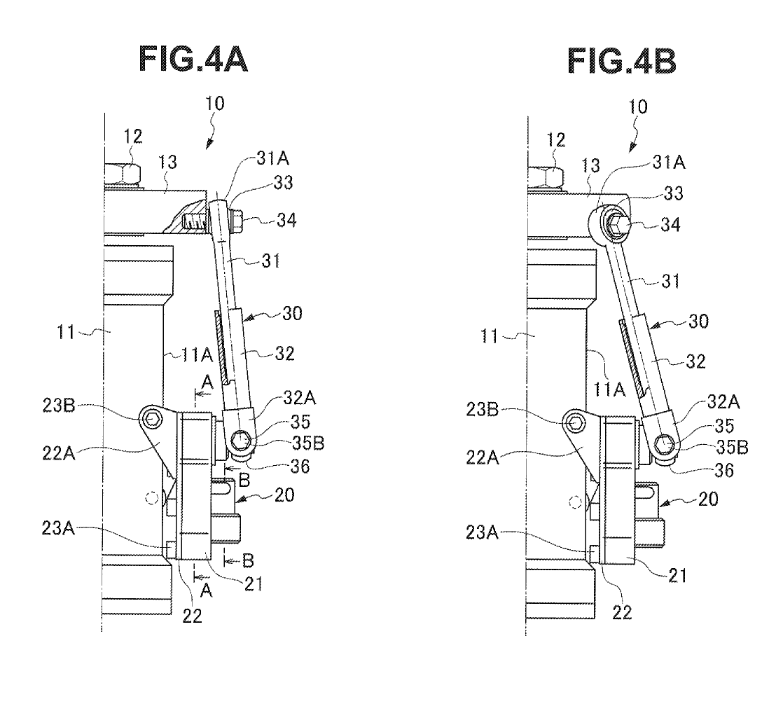

A motorcycle 10 shown in FIGS. 1 to 4B is structured such that a steering shaft 12 is pivoted to a head pipe 11 in a front end of a vehicle body frame (not shown), centers of upper and lower steering brackets 13 and 14 are attached to the steering shaft 12, upper tubes 15A of right and left front forks 15 and 15 are attached to both sides of the upper and lower steering brackets 13 and 14, and an axle of a front wheel is attached to lower tubes (not shown) of the right and left front forks 15 and 15. A handlebar 17 is attached to an upper surface of the upper steering bracket 13 by a fastening member 16.

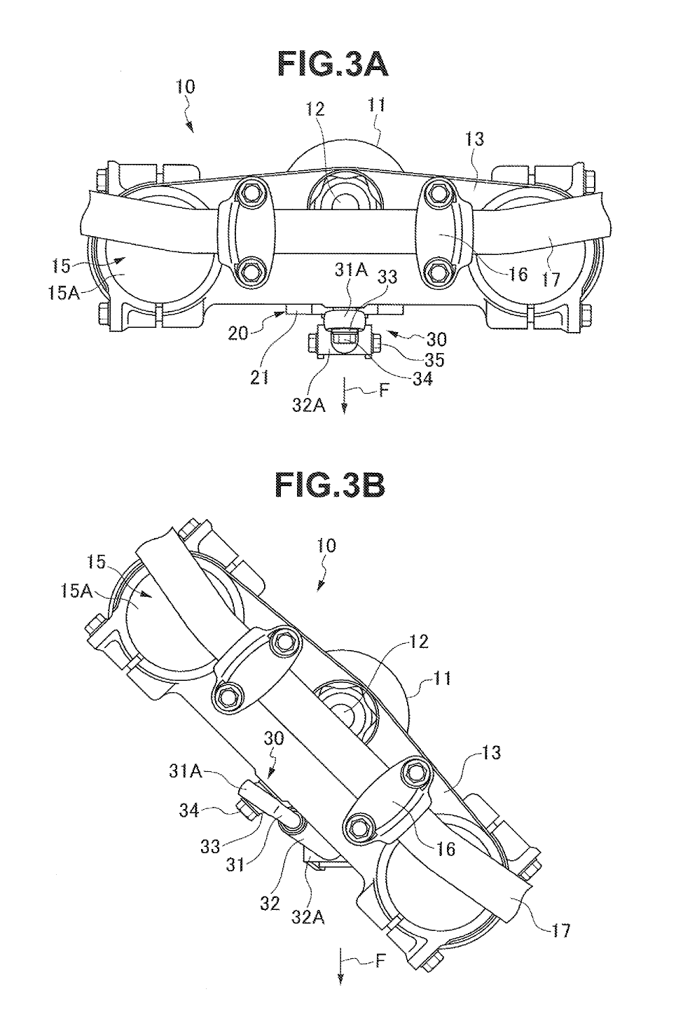

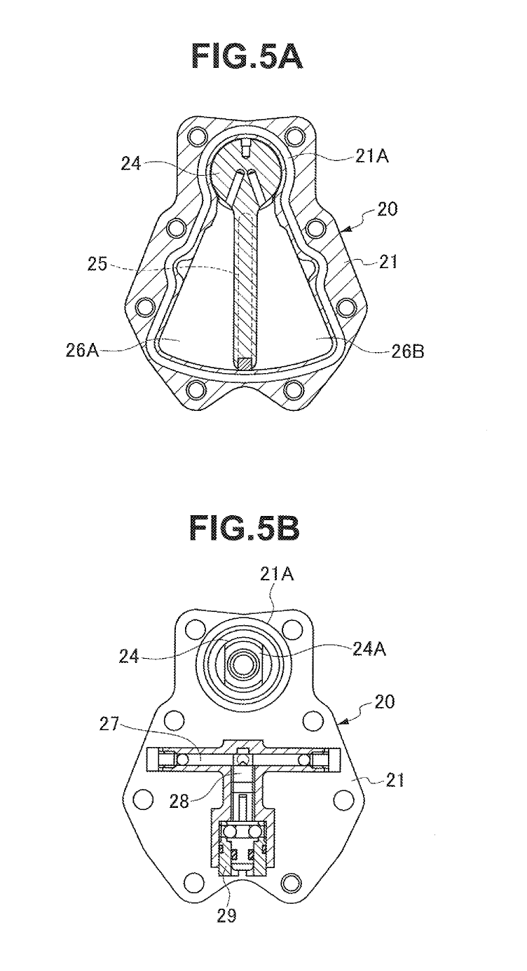

The motorcycle 10 has a steering damping apparatus as shown in FIGS. 1 to 4B. The steering damping apparatus is structured such that a casing 21 of a rotary damper 20 is fixed to a front surface 11A facing to a front side (an arrow F in FIGS. 3A and 3B) in a vehicle forward moving direction of the head pipe 11. The rotary damper 20 assembly can employ all types of known structures. The exemplary embodiment, as shown in FIGS. 1 to 5B, is demonstrated by a casing 21 and a bottom plate 22 thereof connected by a bolt 23A. The rotary damper 20 is accommodated in the casing 21, and has a rotor shaft 24 pivoted to the casing 21 and a boss portion 21A of the bottom plate 22, and a vane 25 protruding in a radial direction from an outer periphery of the rotor shaft 24. The rotary damper 20 comparts a first oil chamber 26A and a second oil chamber 26B filled with an oil in both sides of the vane 25, in an inner portion of the casing 21, is provided with an oil path 27 connecting the first oil chamber 26A and the second oil chamber 26B in the casing 21, and is provided with a needle valve 28 in the oil path 27. The rotary clamper 20 generates an appropriate damping force by moving forward and backward the needle valve 28 within the oil path 27 by an adjuster 29 provided in the casing 21, and throttle adjusting a passage area of the oil path 27. In this case, the rotary damper 20 is fixed to the front surface 11A of the head pipe 11 by attaching both side attaching stays 22A provided in the bottom plate 22 of the casing 21 to the head pipe 11 by a bolt 23B.

In this case, in the present embodiment, an axial direction (an approximately vertical direction) of the steering shaft 12 corresponding to a center axis of rotation of the steering brackets 13 and 14 is arranged so as to be orthogonal to an axial direction (an approximately horizontal direction) of the rotor shaft 24 of the rotary damper 20.

The motorcycle 10 has a rotation transmitting means 30 for rotating the rotor shaft 24 of the rotary damper 20 from a neutral position on the basis of a rotation from a neutral steering position of the steering brackets 13 and 14. The rotation transmitting means 30 is specifically structured as follows.

As shown in FIGS. 1 to 4B, the rotation transmitting means 30 is structured such that a solid first shaft 31 and a hollow second shaft 32 are fitted in such a manner as to be extensible with each other in an axial direction. The first shaft 31 is inserted from a dust seal provided in an opening of the second shaft 32, and is slidably supported to a bush provided in an inner periphery of the second shaft 32.

A leading end portion of the first shaft 31 is coupled to a bolt-like coupling portion 34 provided in a front surface lacing the front side in a vehicle forward moving direction of the upper steering bracket 13 at a time when the upper steering bracket 13 exists at the neutral steering position by a spherical joint 33. The spherical joint 33 is constituted by an outer race installed to a ring-like attaching portion 31A integrally formed in the leading end portion of the first shaft 31, and an inner ball installed to the outer race. The coupling portion 34 is screwed to the upper steering bracket 13 through a center hole provided in the inner ball of the spherical joint 33.

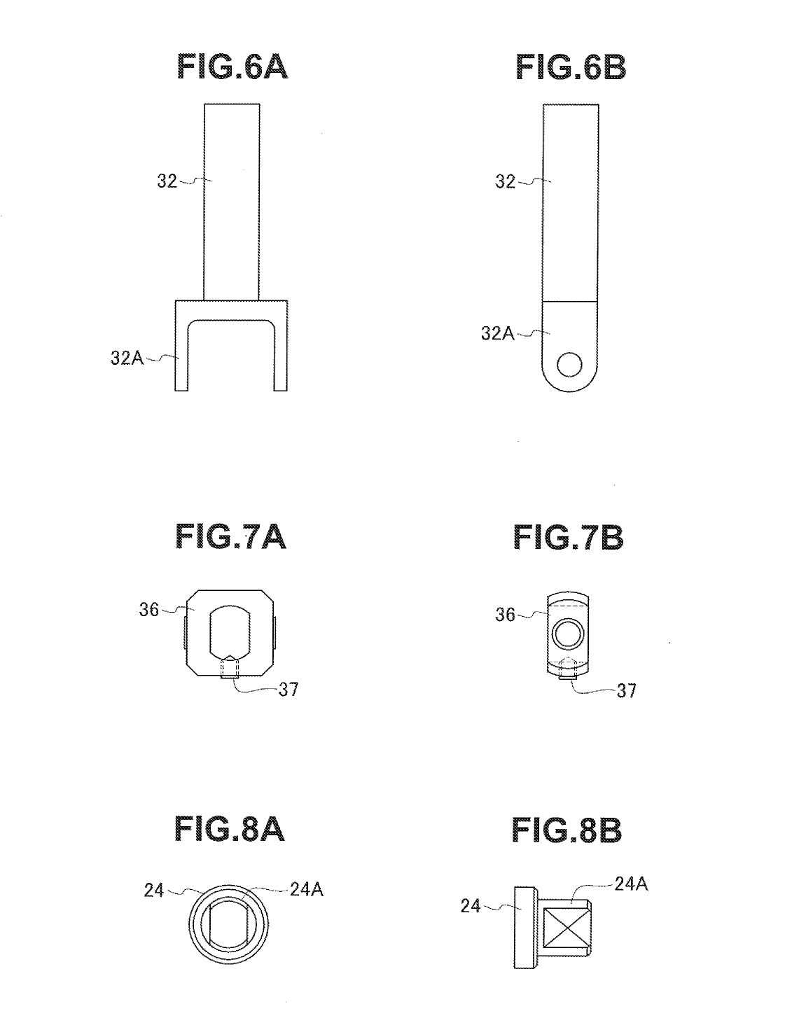

A leading end portion of the second shaft 32 is integrated in a rotating direction of the rotor shaft 24 with respect to the rotor shaft 24 of the rotary damper 20, and is coupled by an oscillating joint 35 which is freely oscillated within a surface including a center shaft of the rotor shaft 24. In the present embodiment, the second shaft 32 is provided with a U-shaped attaching portion 32A integrally formed in a leading end portion, as shown in FIGS. 6A and 6B. The oscillating joint 35 is constituted by a bolt 35B pivoted to each of both arms forming fork ends of the U-shaped attaching portion 32A of the second shaft 32 via a bearing 35A. As described in FIGS. 8A and 8B, at this time, a round bar-like end portion 21A protruding to an outer portion of the casing 21 of the rotor shaft 24 to which the oscillating joint 35 of the rotary damper 20 is attached is formed as a two-surface width portion of both opposing side surfaces, and a square frame-like collar 36 (FIGS. 7A and 7B) having a hole with the same shape as a cross section of the round bar-like end portion 24A is installed. The collar 36 is fixed to the round bar-like end portion 24A of the rotor shaft 24 by an end screw 37. Further, both arms of the U-shaped attaching portion 32A of the second shaft 32 sandwich both outer side surfaces of the collar 36, and the bolt 35B pivoted to both the arms of the U-shaped attaching portion 32A is screwed to both side portions of the collar 36 which has been already fixed to the round rod-like end portion 24A of the rotor shaft 24.

Accordingly, in the motorcycle 10, if the handlebar 17 is steered in a rightward direction, and a rotation of the steering brackets 13 and 14 from the neutral steering position going therewith rotates the rotor shaft 24 of the rotary damper 24 in a counterclockwise direction in a front view by the rotation transmitting means 30, the oil in the first oil chamber 26A is pressurized, and the oil is transferred to the second oil chamber 26B through the oil path 27. The needle valve 28 set by the adjuster 29 applies an appropriate throttle resistance force to the oil in the process of the transfer of the oil path 27, and applies an appropriate damping force to the rotation of the steering brackets 13 and 14.

In the motorcycle 10, at a time of replacing or exchanging the rotary damper 20 to adjust the characteristics of the rotary damper 20, it is possible to easily attach and detach the rotary damper 20 to and from the head pipe 11, by detaching the bolt 35B of the oscillating joint 35 pivoted to the U-shaped attaching portion 32A of the second shaft 32 from the collar 36 in the side of the rotor shaft 24, and detaching the U-shaped attaching portion 32A of the second shaft 32 from the collar 36 in the side of the rotor shaft 24, while keeping the first shaft 31 coupled to the coupling portion 34 in the side of the upper steering bracket 13.

In accordance with the present embodiment, the following operations and effects can be achieved.

(a) The casing 21 of the rotary damper 20 is fixed to the front surface 11A facing to the front side in the vehicle forward moving direction of the head pipe 11. Accordingly, the casing 21 of the rotary damper 20 is arranged in an opposite side to the rider while sandwiching the head pipe 11 therebetween, and does not occupy the space between the rider, and the head pipe 11 and the upper steering bracket 13. Accordingly, the steering motion of the rider is not prevented by the rotary damper 20, and the rotary damper 20 is practical for use in competitive motocross.

(b) The structure is made such as to have the rotation transmitting means 30 for rotating the rotor shaft 24 of the rotary damper 20 from the neutral position on the basis of the rotation from the neutral steering position of the upper steering bracket 13. Accordingly, whatever relation (for example, an orthogonal relation) exists between the axial direction of the rotating shaft (the steering shaft 12) of the upper steering bracket 13, and the axial direction of the rotor shaft 24 of the rotary damper 20, it is possible to rotate the rotor shaft 24 of the rotary damper 20 from the neutral position on the basis of the rotation from the neutral steering position of the upper steering bracket 13 so as to generate the damping force with respect to the rotation of the upper steering bracket 13, the oscillation of the front wheel by extension.

(c) The rotation transmitting means 30 comprises the first and second shafts telescopically fitted to each other in the axial direction, and is structured such as to couple the leading end portion of the first shaft to the coupling portion provided in the front surface 11A facing to the front side in the vehicle forward moving direction of the upper steering bracket 13 at a time when the upper steering bracket 13 exists at the neutral steering position by the spherical joint, and couple the leading end portion of the second shaft to the rotor shaft 24 of the rotary damper 20 by the oscillating joint which is integral in the rotating direction of the rotor shaft 24 and can oscillate within the surface including the shaft of the rotor shaft 24. Accordingly, whatever relation (for example, the orthogonal relation) exists between the axial direction of the rotating shaft (the steering shaft 12) of the upper steering bracket 13, and the axial direction of the rotor shaft 24 of the rotary damper 20, it is possible to stably rotate the rotor shaft 24 of the rotary damper 20 from the neutral position on the basis of the rotation from the neutral steering position of the upper steering bracket 13 so as to generate the damping force with respect to the rotation of the upper steering bracket 13, the oscillation of the front wheel by extension.

As heretofore explained, embodiments of the present invention have been described in detail with reference to the drawings. However, the specific configurations of the present invention are not limited to the illustrated embodiments but those having a modification of the design within the range of the presently claimed invention are also included in the present invention. For example, in the present invention, the leading end portion of the first shaft constructing the rotation transmitting means can be coupled to the coupling portion provided in the lower steering bracket by the spherical joint.

Although the invention has been illustrated and described with respect to several exemplary embodiments thereof, it should be understood by those skilled in the art that the foregoing and various other changes, omissions and additions may be made to the present invention without departing from the spirit and scope thereof. Therefore, the present invention should not be understood as limited to the specific embodiment set out above, but should be understood to include all possible embodiments which can be encompassed within a scope of equivalents thereof with respect to the features set out in the appended claims.

What is claimed is:

1. A steering damping apparatus of a motorcycle in which a steering shaft is pivoted to a head pipe in a front end of a vehicle body frame, and a handlebar is attached to a steering bracket attached to the steering shaft, comprising:
a casing of a rotary damper is fixed to a front surface facing to a front side in a vehicle forward moving direction of the head pipe; and
the steering damping apparatus has a rotation transmitting means for rotating a rotor shaft of the rotary clamper from a neutral position on the basis of a rotation of the steering bracket from a neutral steering position.

2. A steering damping apparatus of a motorcycle according to claim 1, wherein the rotation transmitting means comprises first and second shafts telescopically fitted to each other in an axial direction, couples a leading end portion of the first shaft to a coupling portion provided in the front surface facing to the front side in the vehicle forward moving direction of the steering bracket at a time when the steering bracket exists at the neutral steering position by a spherical joint, and couples a leading end portion of the second shaft to the rotor shaft of the rotary damper by an oscillating joint which is integral in a rotating direction of the rotor shaft and freely oscillates within a surface including an axis of the rotor shaft.

3. A steering damping apparatus of a motorcycle according to claim 2, wherein the spherical joint is constituted by an outer race installed to a ring-like attaching portion integrally formed in the leading end portion of the first shaft, and an inner ball installed to the outer race, and the coupling portion is formed as a bolt shape, and is screwed to the steering bracket through a center hole provided in the inner hall of the spherical joint.

4. A steering damping apparatus of a motorcycle according to claim 2, wherein the oscillating joint is constituted by a bolt pivoted to each of both arms forming fork ends of a U-shaped attaching portion integrally formed in the leading end portion of the second shaft via a bearing.

5. A steering damping apparatus of a motorcycle according to claim 3, wherein the oscillating joint is constituted by a bolt pivoted to each of both arms forming fork ends of a U-shaped attaching portion integrally formed in the leading end portion of the second shaft via a bearing.

6. A steering damping apparatus of a motorcycle according to claim 1, wherein an axial direction of the steering shaft and an axial direction of the rotor shaft of the rotary damper are arranged so as to be orthogonal to each other.

7. A steering damping apparatus of a motorcycle according to claim 2, wherein an axial direction of the steering shaft and an axial direction of the rotor shaft of the rotary damper are arranged so as to be orthogonal to each other.

8. A steering damping apparatus of a motorcycle according to claim 3, wherein an axial direction of the steering shaft, and an axial direction of the rotor shaft of the rotary damper are arranged so as to be orthogonal to each other.

9. A steering damping apparatus of a motorcycle according to claim 4, wherein an axial direction of the steering shaft and an axial direction of the rotor shaft of the rotary damper are arranged so as to be orthogonal to each other.

10. A steering damping apparatus of a motorcycle according to claim 5, wherein an axial direction of the steering shaft and an axial direction of the rotor shaft of the rotary damper are arranged so as to be orthogonal to each other.
